(19) United States
(12) Patent Application Publication
(10) Pub. No.: US 2017/0043997 A1
(43) Pub. Date: Feb. 16, 2017

(54) METERING SYSTEM FOR A TANK TRAILER

(71) Applicant: Trade Star, LLC, St. George, UT (US)

(72) Inventors: Robert Scott, Preston, ID (US); Kevin Tallman, St. George, UT (US); Beau Davis, St. George, UT (US)

(21) Appl. No.: 15/236,227

(22) Filed: Aug. 12, 2016

Related U.S. Application Data
(60) Provisional application No. 62/205,598, filed on Aug. 14, 2015.

(51) Int. Cl. B67D 7/16; B67D 7/38; B67D 7/62; F16K 24/04

(52) U.S. Cl. CPC B67D 7/16; F16K 24/04; B67D 7/38; B67D 7/62

(57) ABSTRACT

A tank trailer mounted metering system is disclosed. The system includes a fluid conduit extending between an inlet and an outlet. The inlet is configured for connecting to a fluid supply, and the outlet is connected to a tank of a tank trailer. The system also includes a pump positioned along the fluid conduit between the inlet and the outlet. The pump is configured to move a fluid through the fluid conduit. The system includes an air eliminator box positioned along the fluid conduit between the pump and the outlet. The air eliminator box is configured to remove air from the fluid. The system also includes a mass flow meter positioned along the fluid conduit between the air eliminator box and the outlet, and an orifice plate positioned at an outlet of the mass flow meter.

### INCORPORATION BY REFERENCE TO ANY PRIORITY APPLICATIONS

This application claims priority to Provisional U.S. Patent Application No. 62/205,598, filed on Aug. 14, 2015. Any and all applications for which a foreign or domestic priority claim is identified in the Application Data Sheet as filed with the present application are hereby incorporated by reference under 37 CFR 1.57.

### BACKGROUND

In the field of oil transportation, accurate metering of oil is important as oil is transported from a well site, to a refinery, and ultimately to consumers. During this process, oil may be bought and sold (or otherwise transferred) many times. At each transfer it is essential that the quantity of oil exchanged is accurately measured. Historically, a Lease Automatic Custody Transfer (LACT) unit (or other type of metering device) has been used to meter oil during these exchanges, and accordingly, a LACT unit has been required at every transfer point. For example, each delivery point typically must have a LACT unit to meter oil as it is transferred to a tank trailer for transport. Installing a LACT unit at every well site, as well as every other exchange point, can be expensive and involve the installation of complex and expensive machinery. In other fields, other types of liquid are similarly metered as it is transferred into and out of tank trailers for transport.

### SUMMARY

This disclosure is directed to systems for metering oil that can be installed on a tank trailer. Embodiments of these systems can be used to substantially accurately measure the quantity of liquids (such as oil, for example) transferred into or out of the tank trailer. In some embodiments, because the systems are located on the tank trailer, it may not be necessary to have a stand-alone LACT unit (or other type metering device) at every location where oil is transferred into or out of the tanker.

In a first aspect, a tank trailer mounted metering system is disclosed. The system includes a fluid conduit extending between an inlet and an outlet. The inlet is configured for connecting to a fluid supply. The outlet is connected to a tank of a tank trailer. The system includes a pump positioned along the fluid conduit between the inlet and the outlet. The pump is configured to move a fluid through the fluid conduit. The system includes an air eliminator box positioned along the fluid conduit between the pump and the outlet. The air eliminator box includes a fluid inlet, a fluid outlet positioned vertically lower than the fluid inlet, one or more internal baffles disposed between the fluid inlet and the fluid outlet, and an air outlet. The system also includes a flow meter positioned along the fluid conduit between the air eliminator box and the outlet.

In some embodiments, the system further comprises an orifice plate positioned along the fluid conduit at an outlet of the flow meter. In some embodiments, the flow meter is a mass flow meter. In some embodiments, the flow meter is a Coriolis meter. In some embodiments, the air eliminator box is positioned vertically higher than the flow meter. In some embodiments, the system further comprises a strainer positioned along the fluid conduit between the pump and the flow meter. In some embodiments, the strainer includes a mesh screen and an air outlet. In some embodiments, the strainer is positioned vertically higher the flow meter.

In some embodiments, a portion of the fluid conduit immediately prior to an inlet to the flow meter is substantially straight. In some embodiments, the portion of the fluid conduit is horizontally oriented. In some embodiments, the portion of the fluid conduit is at least about three feet long. In some embodiments, the portion of the fluid conduit is at least about five feet long. In some embodiments, the portion of the fluid conduit includes the air eliminator box.

In some embodiments, a portion of the fluid conduit immediately prior to an inlet of the flow meter includes two or fewer bends. In some embodiments, the portion of the fluid conduit is at least about five feet in length. In some embodiments, the portion of the fluid conduit is at least about three feet in length. In some embodiments, the two or fewer bends are each about sixty degrees or less. In some embodiments, the two or fewer bends are each about forty-five degrees or less.

In some embodiments, the one or more baffles are separated from a bottom surface of the air eliminator by a first gap and separated from a top surface of the air eliminator by a second gap. In some embodiments, the first gap is larger than the second gap. In some embodiments, the one or more baffles comprise five baffles. In some embodiments, the air eliminator box comprises an upper surface including a sloped portion.

In a second aspect, another tank trailer mounted metering system is disclosed. The system includes a fluid conduit extending between an inlet and an outlet. The inlet is configured for connecting to a fluid supply. The outlet is connected to a tank of a tank trailer. The system also includes a pump positioned along the fluid conduit between the inlet and the outlet. The pump is configured to move a fluid through the fluid conduit. The system also includes a strainer positioned along the fluid conduit between the pump and the outlet. The strainer includes a mesh screen and an air outlet. The system also includes a flow meter positioned along the fluid conduit between the strainer and the outlet. In some embodiments, the system also includes an orifice plate positioned along the fluid conduit at an outlet of the flow meter.

In a third aspect, another tank trailer mounted metering system is disclosed. The system includes a fluid conduit extending between an inlet and an outlet. The inlet is configured for connecting to a fluid supply. The outlet is connected to a tank of a tank trailer. The system also includes a pump positioned along the fluid conduit between the inlet and the outlet. The pump is configured to move a fluid through the fluid conduit. The system also includes a flow meter positioned along the fluid conduit between the pump and the outlet. The system also includes a portion of the fluid conduit immediately prior to an inlet to the mass flow meter that is substantially straight.

In some embodiments, the portion of the fluid conduit is at least about five feet in length. In some embodiments, the portion of the fluid conduit is at least about three feet in length.

In some embodiments, the system also includes an air eliminator box positioned along the fluid conduit between the pump and the outlet. In some embodiments, the air eliminator box includes a fluid inlet, a fluid outlet positioned vertically lower than the fluid inlet, one or more internal baffles disposed between the fluid inlet and the fluid outlet, and an air outlet. In some embodiments, the air eliminator box is positioned within the portion of the fluid conduit. In some embodiments, the air eliminator box is positioned vertically higher than the flow meter. In some embodiments, the one or more baffles are separated from a bottom surface of the air eliminator by a first gap and separated from a top surface of the air eliminator by a second gap. In some embodiments, the first gap is larger than the second gap. In some embodiments, the one or more baffles comprise five baffles. In some embodiments, the air eliminator box comprises an upper surface including a sloped portion.

In some embodiments, the system also includes an orifice plate positioned along the fluid conduit at an outlet of the flow meter. In some embodiments, the flow meter is a mass flow meter. In some embodiments, the flow meter is a Coriolis meter. In some embodiments, the system also includes a strainer positioned along the fluid conduit between the pump and the flow meter. In some embodiments, the strainer includes a mesh screen and an air outlet.

In a fourth aspect, another tank trailer mounted metering system is disclosed. The system includes a fluid conduit extending between an inlet and an outlet. The inlet is configured for connecting to a fluid supply. The outlet is connected to a tank of a tank trailer. The system also includes a pump positioned along the fluid conduit between the inlet and the outlet. The pump is configured to move a fluid through the fluid conduit. The system also includes a flow meter positioned along the fluid conduit between the pump and the outlet. The system includes a portion of the fluid conduit immediately prior to an inlet of the flow meter that includes two or fewer bends. In some embodiments, the system includes four or fewer bends.

In some embodiments, the portion of the fluid conduit is at least about five feet in length. In some embodiments, the portion of the fluid conduit is at least about three feet in length. In some embodiments, the two or fewer bends are each about sixty degrees or less. In some embodiments, the two or fewer bends are each about forty-five degrees or less.

In some embodiments, the system also includes an air eliminator box positioned along the fluid conduit between the pump and the outlet. In some embodiments, the air eliminator box includes a fluid inlet, a fluid outlet positioned vertically lower than the fluid inlet, one or more internal baffles disposed between the fluid inlet and the fluid outlet, and an air outlet. In some embodiments, the air eliminator box is positioned within the portion of the fluid conduit. In some embodiments, the air eliminator box is positioned vertically higher than the flow meter.

In some embodiments, the one or more baffles are separated from a bottom surface of the air eliminator by a first gap and separated from a top surface of the air eliminator by a second gap. In some embodiments, the first gap is larger than the second gap. In some embodiments, the one or more baffles comprise five baffles. In some embodiments, the air eliminator box comprises an upper surface including a sloped portion.

In some embodiments, the system also includes an orifice plate positioned along the fluid conduit at an outlet of the flow meter. In some embodiments, the flow meter is a mass flow meter. In some embodiments, the flow meter is a Coriolis meter. In some embodiments, the system also includes a strainer positioned along the fluid conduit between the pump and the flow meter, the strainer including a mesh screen and an air outlet.

These and other aspects of the disclosure are described below with reference to the figures. The features of the aspects summarized above may be modified, removed, duplicated, and/or combined with features of any of the other aspects described above or elsewhere through this application or as apparent to one of ordinary skill in the art based on this disclosure.

### BRIEF DESCRIPTION OF THE DRAWINGS

The features and advantages of the metering systems for tank trailers described herein will become more fully apparent from the following description and appended claims, taken in conjunction with the accompanying drawings. These drawings depict only several embodiments in accordance with the disclosure and are not to be considered limiting of its scope. In the drawings, similar reference numbers or symbols typically identify similar components, unless context dictates otherwise. The drawings may not be drawn to scale.

FIG. 1 shows an embodiment of a metering system installed on a tank trailer.

FIG. 2 shows a schematic representation of one embodiment of metering system.

FIG. 3 shows a cross-sectional view of an embodiment of an air elimination box that can be included in some embodiments of the metering systems described herein.

FIG. 4 illustrates one embodiment of a metering system attached to a tank trailer.

FIG. 5 illustrates another embodiment of a metering system attached to a tank trailer.

### DETAILED DESCRIPTION

This disclosure presents metering systems that can be installed on tank trailers for substantially accurately measuring the quantity of oil (or other liquids) pumped into or out of tank trailers. Although the metering systems described herein are useable for metering all types of liquids, for ease of description, the following description will refer to oil. Nonetheless, the metering systems described herein are not limited to use with oil and are capable of use with all types of liquids.

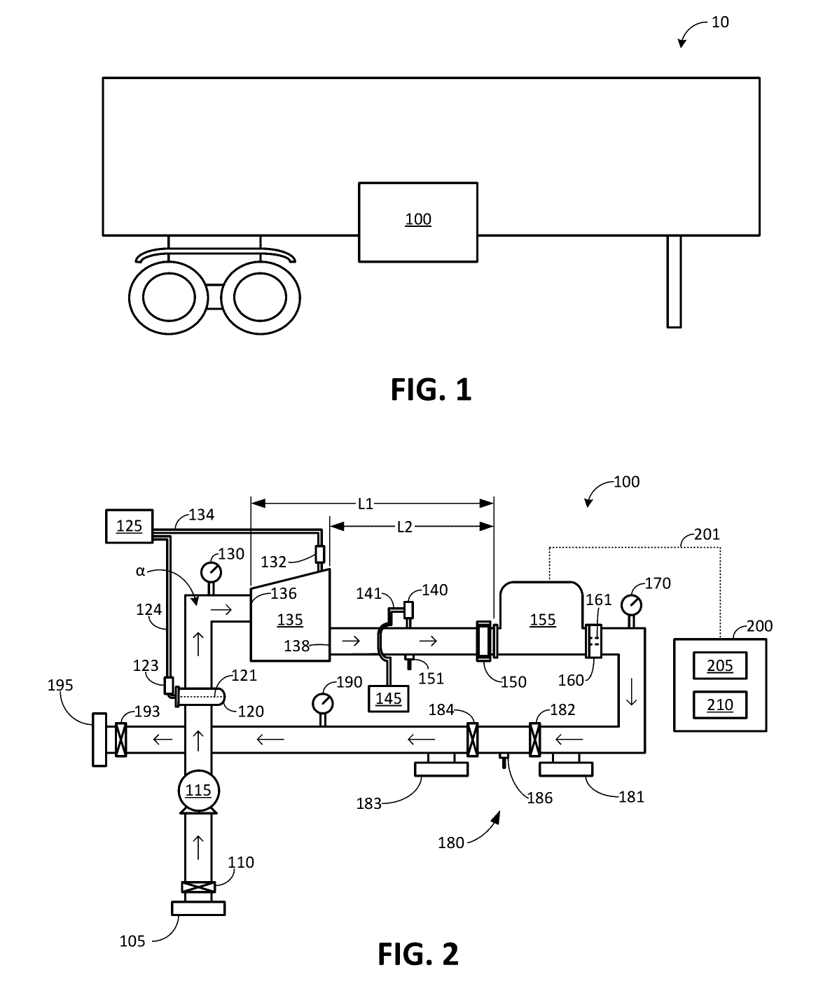

FIG. 1 shows an embodiment of a metering system 100 installed on a tank trailer 10. The metering system 100 is shown in FIG. 2 in greater detail. As shown in FIG. 1, the metering system 100 is installed directly on the tank trailer 10. In some embodiments, the metering system 100 is configured to be retrofitted into the existing connections on the tank trailer 10. For example, the metering system 100 can intake oil at the same location as traditional tank trailers and use the existing connection to deposit the oil into the tank. In some embodiments, the connections between the metering system 100 and the tank trailer include rubber dampers to minimize vibration of the metering system 100. In some embodiments, the metering system is attached to the underside and side of the tank trailer 10, forward of the rear wheels, although other positions are possible. The arrangement of the components of the metering system 100 can be adjusted to conform to the shape of the trailer while also following the principles outlined below.

FIG. 2 illustrates schematically the metering system 100, according to one embodiment. In the illustrated embodiment, the metering system 100 includes components (discussed below) arranged along a fluid conduit from an inlet 105 to an outlet 195. In FIG. 2, arrows illustrate the flow path of oil along the fluid. The fluid conduit may comprise rigid pipes and/or flexible hoses. In some embodiments, the rigid pipes and/or flexible hoses of the fluid conduit have a diameter of preferably 4 inches. In some embodiments, the rigid pipes and/or flexible hoses of the fluid conduit have a diameter of approximately 4 inches, 3 inches, or 2 inches, although other diameters (larger and smaller) are possible. In some embodiments, the diameter of the rigid pipes and/or flexible hoses of the fluid conduit is substantially constant along the entire length of the fluid conduit. In some embodiments, the diameter of the rigid pipes and/or flexible hoses of the fluid conduit varies along the length of the fluid conduit. For example, in some embodiments, a first section of the fluid conduit may have a first diameter of approximately 4 inches and a second section of the fluid conduit may have a second diameter of approximately 2 inches.

Oil enters the metering system 100 at the inlet 105. The inlet 105 can comprise a hose connection of any type. The inlet 105 can be used to connect the metering system 100 to a hose that is connected to a storage tank, thus allowing oil in the storage tank to be pumped into the metering system 100. In the illustrated embodiment a valve 110 is included upstream of the inlet 105. The valve 110 is operable to open and close the connection into the metering system 100. In some embodiments, the valve 110 can be a manually operated valve. In some embodiments, the valve 110 can be an electronically controlled valve that can be controlled, for example, at a control panel 200. In some embodiments, the valve 110 is configured to automatically open when a hose is coupled to the inlet 105 and close when a hose is uncoupled to the inlet 105. In some embodiments, the valve 110 can be omitted.

In the illustrated embodiment, the metering system 100 includes a pump 115. The pump 115 can be configured to draw oil into the metering system 100 through the inlet 105 and push the oil through the remainder of the metering system 100. In some embodiments, the pump 115 is a positive displacement pump, such as a gear pump, screw pump, etc., although other types of pumps are possible. In some embodiments, the pump 115 is powered hydraulically. This may be advantageous because hydraulic lines may be run relatively simply from the pump 115 to a corresponding hydraulic pump attached to a power take off (PTO) on the truck's transmission. The position of the pump 115 in the metering system 100 illustrated in FIG. 2 is provided by way of example only, and other positions for the pump 115 are possible. In some preferred embodiments, the pump 115 is positioned upstream of flow meter 155 (discussed below) such that the pump 115 pushes (rather than pulls) oil through the flow meter 155. In some embodiments, the flow meter 155 may provide a more accurate measurement of the oil when the oil is pushed though the flow meter 155, as opposed to pulled through.

In some embodiments, the pump 115 can be omitted. For example, in some embodiments, a pump external to the metering system 100 (in other words, a pump not included on the tank trailer) can be used to move oil through the metering system 100. In some embodiments, the metering system 100 can include more than one pump 115 positioned along the fluid conduit.

The metering system of FIG. 2 also includes a strainer 120. As illustrated, the strainer 120 includes a mesh screen 121 or perforated plate positioned therein. The strainer 120 is configured to remove air or other gases from the oil in the metering system 100. As the oil passes through the mesh screen 121, some of the air or other gases in the oil are separated. The strainer 120 can be configured with a check valve 123 that allows the air or other gases to exit the strainer 120 while the oil continues along the fluid conduit. In some embodiments, the air or other gases that exits the strainer 120 enters a vent line 124. In some embodiments, the vent line 124 routes the air or other gases to an air eliminator, vent, or gas containment or expulsion system positioned (represented by vent 125 in FIG. 2). The vent 125 can be positioned high on the tank trailer so as to be located away from an operator. In some embodiments, the vent 125 is routed into a gas containment or expulsion system that is included on the tank trailer. In some embodiments, the vent 125 is routed into the tank.

In some embodiments, the strainer 120 is positioned along the fluid conduit of the metering system 100 at a height (measured relative to the ground) above where the flow meter 155 is installed, although this need not be the case in all embodiments. The position of the strainer 120 in FIG. 2 is provided by way of example only and may be varied, as long as the strainer 120 is positioned upstream of the flow meter 155. The strainer 120 may also be configured to remove sediment and/or particulate from the oil. As such, the porosity of the mesh screen 121 may be adjusted as desired. In some embodiments, the strainer 120 may be omitted.

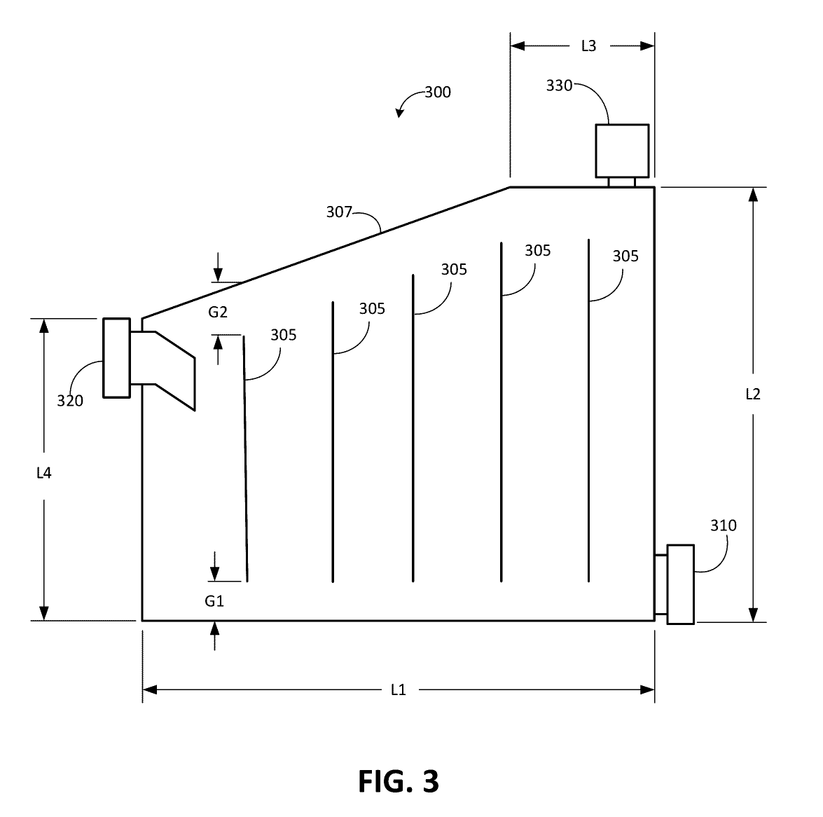

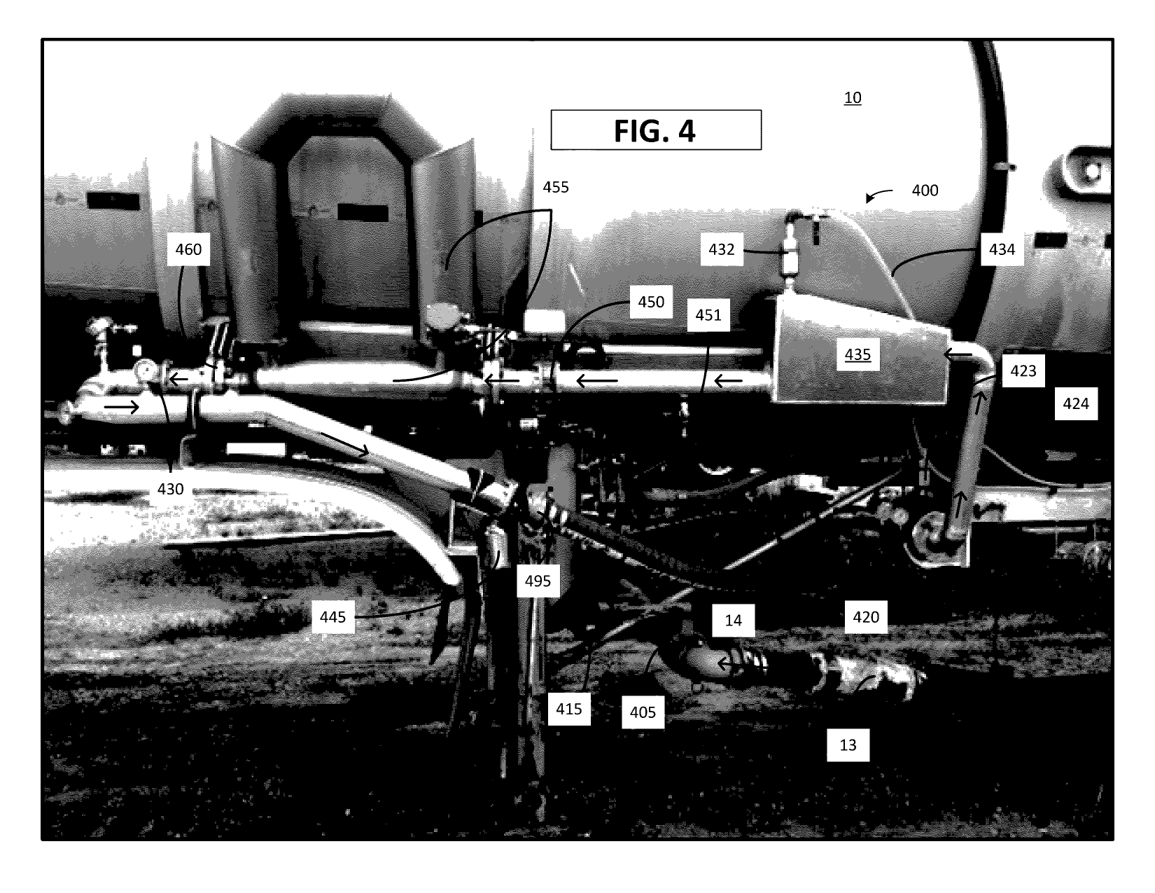

In the illustrated embodiment, the metering system 100 includes an air eliminator box 135. The air eliminator box 135 is configured to remove air or other gases from the oil as the oil passes therethrough. A cross-sectional view of one embodiment of an air eliminator box 135 is shown in FIG. 3 and will be described in detail below. The oil enters the air eliminator box 135 at an inlet 136 and exits the air eliminator box 135 at an outlet 138. In some embodiments, the inlet 136 may be positioned at a height vertically above the outlet 138. In some embodiments, the air eliminator box 135 includes one or more baffles. The one or more baffles may be vertically disposed within the air eliminator box 135 (see FIG. 3 below), although other arrangements are possible. Air or other gases separated from the oil in the air eliminator box 135 exit the air eliminator box 135 through a check valve 132 and vent line 134. The vent line 134 can be connected to a vent 125 as described above. In some embodiments, the check valve 132 and connection to the vent line 134 can be positioned on a top surface of the air elimination box 135. In some embodiments, the check valve 132 and connection to the vent line 134 can be positioned at a height above the inlet 136. In some embodiments, the check valve 132 and connection to the vent line 134 can be positioned at a height above the outlet 138.

In some embodiments, the air eliminator box 135 is positioned along the fluid conduit of the metering system 100 at a height (measured relative to the ground) above where the flow meter 155 is installed, although this need not be the case in all embodiments. The position of the air eliminator box 135 in FIG. 2 is provided by way of example only and may be varied, as long as the air eliminator box 135 is positioned upstream of the flow meter 155. In some embodiments, the air eliminator box 135 and the strainer 120 can be combined, by, for example, including a mesh screen or perforated plate within the air eliminator box 135. In some embodiments, the air eliminator box 135 can be omitted.

The strainer 120 and the air eliminator box 135 are both configured to remove air and other gases from the oil prior to measurement of the oil by the flow meter 155. The inventors of this application have experimentally determined that the use of the strainer 120, the air eliminator box 135, or both, removes air from the oil in the metering system 155 and that the flow meter 155 provides more accurate measurements when the amount of air in the oil at the flow meter 155 is reduced. This is particularly advantageous because air often enters the system when the inlet 105 is initially connected via a hose to the source. This initial air that enters the system can cause unreliable measurements during startup of the system. The inventors of this application have experimentally determined that the use of the strainer 120, the air eliminator box 135, or both, substantially reduces or resolves this issue. Additionally, the strainer 120 and the air eliminator box 135 eliminate or reduce air or gases present in the oil or source and provide increased accuracy for the measurement of the flow meter. This may, for example, allow improved accuracy in measuring hot or gassy oil.

In the illustrated embodiment, the metering system 100 includes a sample solenoid 140 connected via a sample line 141 to a sample pot 145. In some embodiments, the sample solenoid 140 is configured to take samples of the oil passing through the metering system 100. In some embodiments, the sample solenoid 140 can be configured to take a sample of the oil passing through the metering system 100 at prescribed time intervals, for example, every 15 seconds or every 1 minute, or other time periods. The samples are collected in the sample pot 145 as shown. This can be advantageous as the sample is representative of the oil loaded onto the tank trailer over the entire loading process. The sample in the sample pot 145 may be used to test the quality of the oil. Another advantage to this system is that the sample can be taken without requiring a person to get on top of the on-site storage tanks. This increases safety for a driver who would normally check the oil from the top of an on-site storage tanks. Traditionally, samples are taken by lowering a sampling tool down into the oil from the top of an on-site storage tanks. Often, when taking these samples, dangerous gases can be inhaled and, in some cases, can overwhelm the tester causing harm or death.

The position of the sample solenoid 140, sample line 141, and sample pot 145 shown in FIG. 2 are provided for example only. Other positions for the sample solenoid 140, sample line 141, and sample pot 145 are possible. For example, the sample solenoid 140 can be positioned anywhere along the fluid conduit, upstream or downstream of the flow meter 155. In some embodiments, the sample solenoid 140, sample line 141, and sample pot 145 can be omitted.

The metering system 100 includes a flow meter 155. The flow meter 155 can be configured to measure the quantity of oil that passes therethrough. In some embodiments, the flow meter 155 is also configured to measure additional parameters of the oil that passes therethrough, including, for example, temperature, gravity, basic sediment and water (BS & W), among others. In some embodiments, the flow meter 155 is a mass flow meter. In some embodiments, the mass flow meter is a Coriolis meter, although other types of meters are possible. In one embodiment, the flow meter 155 is an FMC Model 83F80, available from FMC Technologies of Houston, Tex. In another embodiment, the flow meter 155 is a CMF300M355N2BAEZZZ available from Micro Motion of Emerson Process Management of Boulder, Colo. Other types and models of flow meters 155 are also usable in the metering system 100, and the metering system 100 is not to be limited to those specifically identified above.

As noted above, the inventors have experimentally determined that reducing the amount of air or other gases in the oil that passes through the meter 155 improves the accuracy of the flow meter 155. Additionally, the inventors have experimentally determined that the accuracy of the flow meter 155 can be improved by delivering a substantially laminar or non-turbulent flow of oil to the flow meter 155. This can be accomplished through several innovative features that can be included in the metering system 100 in some embodiments.

For example, a substantially laminar or non-turbulent flow of oil can be delivered to the flow meter 155 by configuring the metering system 100 such that the fluid conduit is substantially straight prior to the inlet to the flow meter 155. In some embodiments, the fluid conduit of the metering system is substantially straight along a length L1 measured from the air eliminator box 135 to the inlet to the flow meter 155. In some embodiments, the length L1 is at least about 2 feet, at least about 3 feet, at least about 3.5 feet, at least about 4 feet, at least about 4.5 feet, at least about 5 feet, at least about 5.5 feet, at least about 6 feet or longer. In a preferred embodiment, the length L1 is at least about 3.5 feet. In a more preferred embodiment, the length L1 is about 5 feet. In some embodiments, the fluid conduit of the metering system is substantially straight along a length L2 measured from the outlet of the air eliminator box 135 to the inlet to the flow meter 155. In some embodiments, the length L2 is at least about 2 feet, at least about 3 feet, at least about 3.5 feet, at least about 4 feet, at least about 4.5 feet, at least about 5 feet, at least about 5.5 feet, at least about 6 feet or longer. In a preferred embodiment, the length L2 is at least about 3.5 feet. In a more preferred embodiment, the length L2 is about 5 feet. Configuring the fluid conduit to be straight (in other words, substantially free from bends or corners) for a portion prior to inlet to the flow meter 155 has been experimentally determined to improve the accuracy of the flow meter 155.

As another example, providing a substantially laminar or non-turbulent flow of oil to the flow meter 155 can be achieved by reducing the number and severity of bends (one bend is illustrated in FIG. 2 as having an angle α) in the fluid conduit of the metering system 100 leading to the flow meter 155. For example, in some embodiments, it is desirable to reduce the number of bends and/or the severity of bends within about 5 feet, about 7.5 feet, about 10 feet, or about 15 feet of fluid conduit prior to the flow meter 155. This reduces the turbulence in the flow of oil through the system. In some embodiments, this is accomplished by replacing sharp 90 degree bends with two or more bends of lesser degree. For example, one 90 degree bend may be replaced by two 45 degree bends. In some embodiments, the transition into the flow meter 155 itself is configured to be as gradual as possible to minimize turbulence through the flow meter 155. For example, in the schematic, the bend immediately preceding the meter utilizes only a 45 degree connection. Other less severe bends can also be used. For example, a plurality of 30 degree bends can be used.

In some embodiments, the metering system 100 includes a sight glass 150 positioned in the fluid conduit prior to the inlet to the flow meter 155. The sight glass 150 allows an operator to visually inspect the flow of oil into the flow meter 155. Accordingly, the sight glass 150 may be positioned immediately before (or slightly upstream of) the inlet to the flow meter 155. In some embodiments, the sight glass 150 may be positioned in other positions along the fluid conduit. In some embodiments, more than one sight glass 150 may be positioned along the fluid conduit, allowing visual inspection of the flow at a plurality of locations. In some embodiments, the sight glass 150 can be omitted.

As illustrated in FIG. 2, the metering system 100 includes an orifice plate 160. The orifice plate 160 is positioned at the outlet of the flow meter 155. The orifice plate 160 can be configured to increase the back pressure through the flow meter 155. It has been experimentally determined that this increases the accuracy of the flow meter 155. It is believed the back pressure created by the orifice plate 160 may compensate for inconsistencies in the flow rate of the pump 115.

Prior to the disclosure of this application, those of skill in the art have found that installation of metering systems onto tank trailers is particularly difficult because the available hydraulic power system on the tank trailer produces an uneven flow rate through the metering system over the time that it takes to load oil into the tanker, causing inaccurate measurements by the flow meter. The varying flow rate can be due to the viscosity of the hydraulic fluid powering the pump changing as it warms, affecting the flow rate of the pump. This uneven flow rate can cause a mass flow meter to provide inaccurate measurements. In some embodiments, these problems can be reduced or eliminated according to the disclosure provided herein, for example, by including an orifice plate 160 at the outlet of the flow meter 155 to increase back pressure. The strainer 120 and/or air eliminator box 135 may also create back pressure in the metering system 100.

In some embodiments, the orifice plate 160 can be a plate with a hole 161 formed there through. In some embodiments, the diameter of the hole 161 is approximately 2 inches or less. In some embodiments, the diameter 161 of the hole is approximately 1 inch or less. In some embodiments, the orifice plate 160 may comprise a plate perforated by small holes. The orifice plate 160 may comprise a thin plate. The orifice plate 160 may comprise steel. In some embodiments, the orifice plate 160 may be omitted.

As illustrated in FIG. 2, the metering system 100 may include a prover connection system 180. In the illustrated embodiment, the prover connection system 180 includes a first prover connection 181, a first valve 182, a bleed valve 186, a second valve 184, and a second prover connection 183. The prover connection 180 system allows the metering system 100 to be connected to a proving meter that can be used to verify the measurements taken by the flow meter 155. The proving meter can be connected between the first prover connection 181 and the second prover connection 183, and the first and second valves 182, 184 can be closed to ensure that the flow of oil passes through the proving meter. The bleed valve 186 can be used to drain any oil caught between the two valves 182, 184. Other systems for connecting the metering system 100 to a proving meter are possible. In preferred embodiments, the prover connection system 180 is located downstream of the flow meter 155 so as to not create turbulence prior to the flow meter 155. In some embodiments, the prover connection system 180 can be omitted.

The metering system 100 includes an outlet 195. The outlet 195 can be used to deliver the oil into the tank trailer 10. In some embodiments the outlet 195 includes a valve 193. The valve 193 can be similar to the valve 110 that is associated with the inlet 105 and described above.

The metering system 100 can also include a control panel 200 as illustrated in FIG. 2. The control panel may include a head unit 205 electrically connected to the flow meter 155, as illustrated by connection 201. The control panel 200 can also include display/input 210 for accessing information from and configuring the metering system 100. In some embodiments, the control panel 200 may include transmission circuitry, such as wireless circuitry, such that information about the metering system 100 may be accessed and/or controlled remotely. In some embodiments, the control panel 200 is electrically connected to and controls additional components of the metering system 100. For example, in addition to connection to the flow meter 155, the control panel 200 may be electrically connected to and configured to control, for example, the pump 115, the sample solenoid 140, and/or valves 110, 193, among other components.

The metering system can also include pressure gauges (for example, the illustrated pressure gauges 130, 170, 190) that measure and indicate the pressure in the fluid conduit. The pressure gauges can provide a visual indication of the pressure and/or can provide the measured pressure to the control panel 200. The position of the pressure gauges 130, 170, 190 shown in FIG. 2 is provided for example only, and the position and number of pressure gauges in the metering system 100 can be varied. In some embodiments, the pressure gauges may be omitted. The metering system can also include one or more bleed valves (for example, the illustrated bleed valves 151, 186). The position of the bleed valves 151, 186 are provided for example only, and the position and number of bleed valves in the metering system 100 can be varied. In some embodiments, the bleed valves may be omitted.

FIG. 3 shows a cross-sectional view of an embodiment of an air elimination box 300 that is included in some embodiments of the metering systems described herein. For example, the air elimination box 300 can be used as the air elimination box 135 described above with reference to FIG. 2.

The air elimination box 300 includes an enclosed housing having an oil inlet 320, an oil outlet 310, and an air outlet 330. In the illustrated embodiment, the oil inlet 320 is positioned on an opposite side than the oil outlet 310, although this need not be the case in all embodiments. For example, in some embodiments, the oil inlet 320 and the oil outlet 310 are positioned on the same side or on adjacent sides. In some embodiments, the oil inlet 320 and the oil outlet 310 are oriented at approximately 90 degrees to each other, for example, when oriented on adjacent sides of the air elimination box. In preferred embodiments, the oil inlet 320 is located vertically higher than the oil outlet 310.

In some embodiments, the oil inlet 320 includes a downward projection inside of the air elimination box 300. For example, after entering the air elimination box 300 the oil inlet 320 can include a short projection that curves downwardly or extends at an angle downwardly. In some embodiments, the projection is approximately 3 inches, approximately 2 inches, approximately 1 inch, or approximately 0.5 inches. In some embodiments, the projection can be omitted.

The air outlet 330 can be positioned on a top surface of the air elimination box 300 or an upper portion of any of the side surfaces. In preferred embodiments, the air outlet 330 is positioned vertically higher than the oil inlet 320. In some embodiments, the air outlet 330 includes a check valve that allows air or gases to exit but substantially prevents the exit of oil.

The interior of the air elimination box 300 includes one or more baffles 305. In the illustrated embodiment, the air elimination box includes five baffles 305, although other numbers are possible. For example, in some embodiments, the air elimination box 300 includes one, two, three, four, five, six, seven, eight, nine, ten, or more baffles 305. In the illustrated embodiment, the baffles 305 are vertically disposed within the air elimination housing and extend across the width of the air elimination box 300 (in other words, into and out of the page of FIG. 3). The baffles 305 are spaced from a bottom surface of the air elimination box 300 by a gap G1 and spaced from a top surface of the air elimination box 300 by a gap G2. In some embodiments, the gaps G1 and G2 are the same for all the baffles 305, while, in other embodiments, the gaps G1 and G2 may vary for one or more of the baffles. In some embodiments, the gaps G1 are approximately between 0.5 inches and 5 inches, between 1.5 inches and 3 inches, or between 2.5 inches and 3 inches. In some embodiments, the gaps G2 are approximately between 0.5 inches and 5 inches, between 1 inch and 2 inches, or about 1.5 inches. Other dimensions for the gaps G1 and G2 are possible, however. In some embodiments, the gaps G1 below and/or G2 above the baffle 305 nearest to the oil inlet 320 is smaller than the remaining gaps G1. In some embodiments, the size of the gaps G1 above and/or G2 below the baffles increase with each baffle from the oil inlet 320 to the oil outlet 310. In some embodiments, the size of the gaps G1 above and/or G2 below the baffles decrease with each baffle from the oil inlet 320 to the oil outlet 310.

In the illustrated embodiment, the air elimination box 300 includes an upper surface with a sloped portion 307. In some embodiments, the sloped portion 307 may be omitted. In some embodiments, the air elimination box 300 may include a thickness (measured into and out of the page of FIG. 3) that is between approximately 3 and approximately 12 inches, between approximately 4 and approximately 8 inches, between approximately 4 and approximately 6 inches, or approximately 5 inches, although other thicknesses are possible. As shown in FIG. 3, the air elimination box can include dimensions L1, L2, L3, and L4, although other shapes for the air elimination box 300 are possible. In some embodiments, L1 can be between approximately 12 inches and approximately 36 inches, between approximately 18 inches and approximately 30 inches, between approximately 21 inches and approximately 27 inches, approximately 24 inches or approximately 24.5 inches, although other lengths are possible. In some embodiments, the length L2 can be between approximately 8 inches and approximately 20 inches, between approximately 10 inches and approximately 16 inches, approximately 12 inches, approximately 14 inches, or approximately 14.5 inches, although other lengths are possible. In some embodiments, L3 can be between approximately 2 and approximately 8 inches, between approximately 3 and approximately 6 inches, approximately 4 inches, or approximately 4.5 inches, although other lengths are possible. In some embodiments, L4 can be between approximately 6 and approximately 14 inches, between approximately 8 and approximately 12 inches, approximately 8 inches, approximately 10 inches, or approximately 10.5 inches, although other lengths are possible.

In some embodiments, the air elimination box 300 can be shaped to fit against the tank trailer 10. For example, the air elimination box 300 can include one or more curved sides that conform to the curved side of the tank trailer.

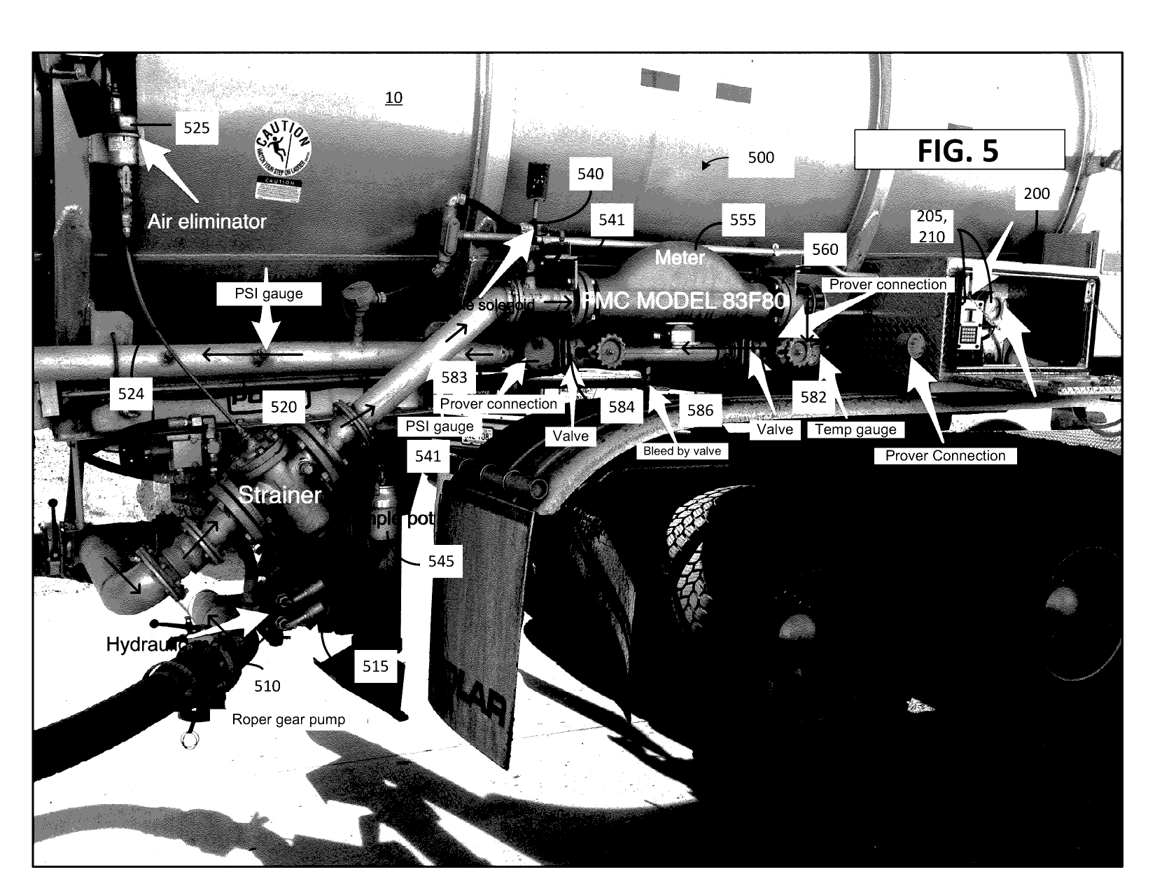

FIG. 4 illustrates one embodiment of a metering system 400 attached to a tank trailer 10. In some embodiments, components of the metering system 400 may be substantially similar to similarly numbered elements of the metering system 400, except where noted. For example, in some embodiments pump 415 in the metering system 400 may be substantially similar to the pump 115 described above. Further, for clarity of the figure, not all components of the metering system 400 have been labeled. The metering system 400 can include any of the components described with reference to the metering system 100 as well as duplications and modifications thereof. Finally, arrows in FIG. 4 illustrate the flow of oil through the metering system 400. The components of the metering system 400 will be described along the flow path of oil through the metering system 400.

In the illustrated embodiment, the metering system 400 includes a fluid conduit with an inlet 405. In FIG. 4, an intake hose 13 is shown connected to the inlet 405. The intake hose 13 supplies oil from, for example, a storage tank (not shown). Pump 415 moves the oil along the fluid conduit. In the illustrated embodiment, the pump 415 is a Roper gear pump. The oil proceeds along the fluid conduit through a strainer 420 and an air elimination box 435. The strainer 420 includes a check valve 423 connected to a vent line 424. The air elimination box 435 also includes a check valve 432 connected to a vent line 434. The vent lines 424, 434 may be connected to a vent (not shown) or into the tank of the tank trailer 10. The air elimination box 435 and the strainer 420 are configured as above to reduce the amount of air in the oil, thereby improving the accuracy of flow meter 455.

The oil exits the air elimination box 435 and proceeds through a straight section of pipe before entering the flow meter 455. The straight section of pipe is configured to decrease the turbulence or create a laminar flow of the oil before entering the flow meter 455. The pipe includes a bleed valve 451. In the illustrated embodiment, the flow meter 455 is a Micro Motion CMF300M355N2BAEZZZ. The oil is measured as it passes through the meter 455. An orifice plate 460 is positioned at the exit of the flow meter 455. The exiting oil proceeds past pressure gauges before reaching the outlet 495. A hose 14 routes the oil exiting the outlet into the tank of the tank trailer 10. The metering system 400 of FIG. 4 presents merely one embodiment of a metering system that is configured according to some of the principles of this disclosure, and this disclosure is not intended to be limited to the metering system 400 shown in FIG. 4.

FIG. 5 illustrates another embodiment of a metering system 500 attached to a tank trailer 10. In some embodiments, components of the metering system 500 may be substantially similar to similarly numbered elements of the metering system 500, except where noted. For example, in some embodiments pump 515 in the metering system 500 may be substantially similar to the pump 115 described above. Further, for clarity of the figure, not all components of the metering system 500 have been labeled. The metering system 500 can include any of the components described with reference to the metering system 100 as well as duplications and modifications thereof. Finally, arrows in FIG. 4 illustrate the flow of oil through the metering system 500. The components of the metering system 500 will be described along the flow path of oil through the metering system 500.

Oil enters the metering system 500 through an inlet 510. Pump 515 moves the oil through the fluid conduit of the metering system 500. In the illustrated embodiment, the pump 515 is a Roper gear pump. The pump 515 moves the oil through a strainer 520. The strainer is connected via a vent line to an air eliminator 525 or vent. The oil continues through the strainer 520. The piping leading to the flow meter 555 is configured to minimize the number and severity of bends prior to the flow meter 555. For example, in the illustrated embodiment, only one bend of approximately 45 degrees is formed in the pipe in the section leading up to the flow meter 555. A sample solenoid 540 samples the oil and the sample is deposited in a sample pot 545 via a sample line 541. In the illustrated embodiment, the flow 1 meter 555 is an FMC Model 83F80. The flow meter 555 measures the oil as it passes there through. An orifice plate 560 is positioned at the exit of the flow meter 555. The oil flows past a temperature gauge and a prover connection system that includes a first prover connection (not shown) a first valve 582, a bleed valve 586, a second valve 584, and a second prover connection 584. The oil then proceeds to an outlet (not shown) that leads into the tank of the tank trailer 10. A control panel 200, including a meter head 205 and a display/input 210 are also shown in FIG. 5. The metering system 500 of FIG. 5 presents merely one embodiment of a metering system that is configured according to some of the principles of this disclosure, and this disclosure is not intended to be limited to the metering system 400 shown in FIG. 5.

Although the preceding discussion has primarily discussed metering oil into a tank trailer for transportation, the metering system for a tank trailer described herein is applicable to all areas of fluid transportation.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the figures may be combined, interchanged or excluded from other embodiments.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims. Applicant reserves the right to submit claims directed to combinations and sub-combinations of the disclosed inventions that are believed to be novel and non-obvious. Inventions embodied in other combinations and sub-combinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A tank trailer mounted metering system, comprising:
a fluid conduit extending between an inlet and an outlet, the inlet configured for connecting to a fluid supply, the outlet connected to a tank of a tank trailer;
a pump positioned along the fluid conduit between the inlet and the outlet, the pump configured to move a fluid through the fluid conduit;
an air eliminator box positioned along the fluid conduit between the pump and the outlet, the air eliminator box including
a fluid inlet,
a fluid outlet positioned vertically lower than the fluid inlet,
one or more internal baffles disposed between the fluid inlet and the fluid outlet, and
an air outlet; and
a flow meter positioned along the fluid conduit between the air eliminator box and the outlet.

2. The system of claim 1, further comprising an orifice plate positioned along the fluid conduit at an outlet of the flow meter.

3. The system of claim 1, wherein the flow meter is a mass flow meter.

4. (canceled)

5. The system of claim 1, wherein the air eliminator box is positioned vertically higher than the flow meter.

6. The system of claim 1, further comprising a strainer positioned along the fluid conduit between the pump and the flow meter, the strainer including a mesh screen and an air outlet.

7. The system of claim 6, wherein the strainer is positioned vertically higher the flow meter.

8. The system of claim 1, wherein a portion of the fluid conduit immediately prior to an inlet to the flow meter is substantially straight.

9. The system of claim 8, wherein the portion of the fluid conduit is horizontally oriented.

10. The system of claim 8, wherein the portion of the fluid conduit is at least about three feet long.

11. The system of claim 8, wherein the portion of the fluid conduit is at least about five feet long.

12. The system of claim 8, wherein the portion of the fluid conduit includes the air eliminator box.

13. The system of claim 1, wherein a portion of the fluid conduit immediately prior to an inlet of the flow meter includes two or fewer bends.

14. The system of claim 13, wherein the portion of the fluid conduit is at least about five feet in length.

15. The system of claim 13, wherein the portion of the fluid conduit is at least about three feet in length.

16. The system of claim 13, wherein the two or fewer bends are each about sixty degrees or less.

17. The system of claim 16, wherein the two or fewer bends are each about forty-five degrees or less.

18. The system of claim 1, wherein the one or more baffles are separated from a bottom surface of the air eliminator by a first gap and separated from a top surface of the air eliminator by a second gap.

19. The system of claim 18, wherein the first gap is larger than the second gap.

20. The system of claim 1, wherein the one or more baffles comprise five baffles.

21. The system of claim 1, wherein the air eliminator box comprises an upper surface including a sloped portion.

22-53. (canceled)
